(19) United States
(12) Patent Application Publication
(10) Pub. No.: US 2018/0273249 A1
(43) Pub. Date: Sep. 27, 2018

(54) EMBOSSED GUSSETED CONTAINER AND ROLL

(71) Applicant: HOOD PACKAGING CORPORATION, Burlington (CA)

(72) Inventors: Manuel CHIU, Oakville (CA); Roy Allan NEWSOME, Tyler, TX (US)

(21) Appl. No.: 15/936,624

(22) Filed: Mar. 27, 2018

Related U.S. Application Data
(60) Provisional application No. 62/477,171, filed on Mar. 27, 2017.

(51) Int. Cl. B65D 30/20; B65D 33/00; B65B 5/02; B65B 41/12; B29D 22/00; B29C 59/04; B29C 59/00; B29C 53/04; B65H 18/28

(52) U.S. Cl. CPC B65D 31/10; B65D 33/004; B65B 5/022; B65B 41/12; B29D 22/003; B29K 2105/256; B29C 59/002; B29C 53/04; B65H 18/28; B29C 2793/0027; B29C 2793/009; B29C 59/04

(57) ABSTRACT

A packaging container includes an expandable plastic body having a front wall and a back wall, and a top, a bottom, and sides. Each side of the body has a gusset portion extending along a length thereof. Each gusset portion has gusset segments and a pair of adjacent gusset segments are joined along a common fold line. Each gusset segment has an inner surface and an outer surface. At least one of the gusset segments has an embossed section. The embossed section has a plurality of mounds protruding from one of the inner and outer surfaces and a plurality of depressions corresponding to the mounds within the other of said inner and outer surfaces. A roll for forming a packaging container, and method, are also disclosed.

### CROSS REFERENCE TO RELATED APPLICATIONS

This application claims the priority of US provisional patent application having Ser. No. 62/477,171 and filed on Mar. 27, 2017, the entire contents of which are hereby incorporated by reference.

### TECHNICAL FIELD

The application relates generally to fillable containers and, more particularly, to fillable plastic containers.

### BACKGROUND OF THE ART

Some fillable plastic bags have gussets along their side portions. Each gusset is a folded portion of the bag along one of its peripheral sides. When the bag is unfilled, the gussets are folded to minimise the volume occupied by the bag. As the bag is filled, each gusset expands outwardly, thereby increasing the overall volume and carrying capacity of the bag.

During the filling of such gusseted plastic bags, it occurs that the folds or pleats which form the gussets may stick together. When this occurs, the gussets are prevented from expanding outwardly, and the bag cannot be filled to its full volume. Furthermore, if one or more of the gussets remains folded as the bag is being filled, it may be difficult or impossible to properly seal the bag.

### SUMMARY

In one aspect, there is provided a packaging container, comprising: an expandable plastic body having a front wall and a back wall, and a top, a bottom, and sides, each side of the body having a gusset portion extending along a length thereof, each gusset portion having gusset segments and a pair of adjacent gusset segments are joined along a common fold line, each gusset segment having an inner surface and an outer surface, at least one of the gusset segments having an embossed section, the embossed section having a plurality of mounds protruding from one of the inner and outer surfaces and a plurality of depressions corresponding to the mounds within the other of said inner and outer surfaces.

In another aspect, there is provided a roll for forming a packaging container, the roll comprising: an expandable plastic tube in a rolled-shape having a front wall and a back wall, the front and back walls meeting at sides of the expandable plastic tube, each side of the expandable plastic tube having a gusset portion extending along a length thereof, each gusset portion having gusset segments where a pair of adjacent gusset segments are joined along a common fold line, each gusset segment having an inner surface and an outer surface, at least one of the gusset segments having an embossed section, the embossed section having a plurality of mounds protruding from one of the inner and outer surfaces and a plurality of depressions corresponding to the mounds within the other of said inner and outer surfaces.

In a further aspect, there is provided a method of forming a roll of flexible plastic material, the method comprising: forming a tubing from a sheet of the flexible plastic material, the tubing having side portions; forming a gusset in each of the side portions of the tubing; embossing at least a portion of each gusset to form mounds protruding from one surface of the gusset, and to form depressions in another surface of the same gusset; and winding the tubing into the roll of flexible plastic material.

### DESCRIPTION OF THE DRAWINGS

Reference is now made to the accompanying figures in which:

FIG. 1 is a schematic view of a packaging container according to an embodiment of the present disclosure, a portion of an interior of the packaging container being shown;

FIG. 2 is a schematic view of a packaging container similar to the one shown in FIG. 1 having a different embossed section;

FIG. 3 is a cross-sectional view of a packaging container according to another embodiment of the present disclosure; and

FIG. 4 is a perspective view of a roll of material for forming the packaging container of FIG. 1.

### DETAILED DESCRIPTION

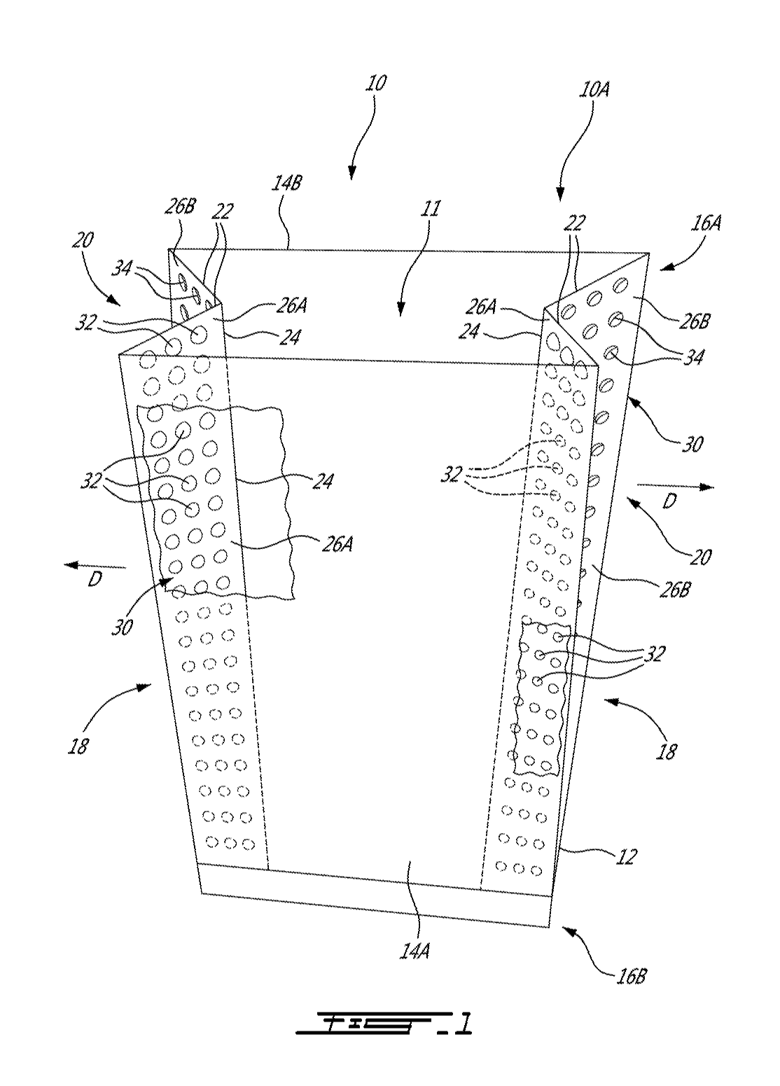

FIG. 1 illustrates a packaging container 10. The packaging container 10 (or simply “container 10”) is used to transport material contained therein. The container 10 therefore has a hollow interior which is filled with any suitable material. It will therefore be appreciated that the container 10 can take many different forms. In the depicted embodiment, the container 10 is in the form of a bag 10A or a pouch having an inner cavity 11 to be filled. In an alternate embodiment, the container 10 is in the form of a box. Other forms for the container 10 are also possible.

The container 10 has an expandable plastic body 12. The body 12 forms the corpus of the container 10 and provides structure thereto. The body 12 is composed of a polymeric material that allows it to expand as it is being filled. In its unfilled stated, the body 12 is unexpanded and remains substantially flat. In the depicted embodiment, the polymeric material of the body 12 is in the form of a plastic film which is shaped to form the body 12 as explained in greater detail below. In at least some embodiments, the plastic material is impervious to air and water.

In the illustrated embodiment, the body 12 has a front wall 14A and a back wall 14B. The front and back walls 14A,14B may be the portions of the body 12 that have the largest surface area. In some configurations of the bag 10A, images and/or text are printed on the front and back walls 14A,14B. The body 12 also has a top 16A and a bottom 16B, as well as sides 18. In the depicted embodiment, the top 16A of the body 12 is left open so that the inner cavity 11 of the bag 10A can be filled via the top 16A. The bottom 16B of the bag 10A is sealed to allow material to accumulate within the inner cavity 11. It will be appreciated that the top 16A and the bottom 16B of the body 12 can be reversed depending on how the bag 10A is filled and/or stacked, among other possible factors. It will be appreciated that the front and back walls 14A,14B of the body 12 may also be reversed.

In the illustrated embodiment, each side 18 of the body 12 extends along the entire length of the bag 10A. In an alternate embodiment, each side 18 extends along only part of the length of the bag 10A. Each side 18 has a gusset portion 20 extending along the entire length of the side 18. In an alternate embodiment, each gusset portion 20 extends along only part of the length of the side 18. Each gusset portion 20 is a folded side portion of the bag 10A when it is unfilled, and the gusset portions 20 expand outwardly in the direction D as the bag 10A is being filled. The expansion of the gusset portions 20 increases the overall volume and carrying capacity of the container 10. The bag 10A of FIG. 1 therefore has expandable side gussets. In an alternate embodiment, at least one of the top 16A and the bottom 16B of the body 12 also have a gusset portion 20.

Each gusset portion 20 has two or more gusset segments 22. Each gusset segment 22 is a pleat or fold of the gusset portion 20 which is joined to other gusset segments 22 and/or to the walls 14A,14B of the body 12. In the illustrated embodiment, the body 12 has two gusset segments 22, and this pair of adjacent gusset segments 22 is joined along a common fold line 24. The common fold line 24 is the boundary between adjacent gusset segments 22, and the line about which adjacent gusset segments 22 are folded. Each gusset segment 22 has an inner surface 26A facing into the interior volume of the bag 10A, and an outer surface 26B facing toward the outside of the bag 10A. In an alternate embodiment, and as described in greater detail below, each gusset portion 20 has more than two gusset segments 22.

One or more of the gusset segments 22 has an embossed section 30. Each embossed section 30 is pattern or relief on the inner and outer surfaces 26A,26B of the gusset segment 22. The embossed section 30 occupies an area of the inner and outer surfaces 26A,26B and provides a tangible texture to the gusset segment 22. More particularly, the embossed section 30 has one or more mounds 32 which protrude from one of the inner and outer surfaces 26A,26B. Each mound 32 is a protrusion from the plane of the corresponding surface 26A,26B, and can be of any suitable shape. Each mound 32 is therefore raised from the plane of the corresponding surface 26A,26B. The mounds 32 are spaced apart from one another on the surface 26A,26B. More particularly, the mounds 32 are spaced apart from one another in a direction along the length of the gusset portion 20 and along a width of each gusset segment 22. In the embodiment of FIG. 1, the mounds 32 protrude from only the inner surfaces 26A of the gusset segments 22. In an alternate embodiment, and as described in greater detail below, the mounds 32 protrude from one or more of the outer surfaces 26B. In the illustrated embodiment, the mounds 32 are unperforated protrusions in the plastic film that makes up the body 12. In an alternate embodiment, the mounds 32 are perforated to allow the bag 10A to breathe through the gusset portion 20.

The embossed section 30 also has a plurality of depressions 34 corresponding to the mounds 32. By “corresponding”, it is understood that each depression 34 is co-located with one of the mounds 32 in that it is located in the same position as the mound 32 but on an opposite surface 26A,26B of the gusset segment 22. For example, and as shown in FIG. 1, the mounds 32 protrude from the inner surfaces 26A of the gusset segments 22 and the depressions 34 are therefore indents into the outer surface 26B of the same gusset segments 22. This colocation of the mounds 32 and the depressions 34 can be achieved in many ways. For example, in the embodiment where the bag 10A is formed from a plastic film, the mounds 32 are formed by pressing an embossing roller against one surface of the plastic film to protrude the surface at the locations of the applied pressure, which will necessarily result in dimples or depressions 34 being formed in the same location as the mounds 32 but on the other surface of the plastic film.

The container 10 disclosed herein therefore has one or more embossed gusset portions 20. It is believed that the “stickiness” that prevents expansion of the gussets when conventional plastic bags are being filled is caused by mating plastic pleats of the gusset. A stickiness or surface tension is formed along these mated plastic surfaces, which is believed to prevent or reduce expansion of these pleats. In contrast, the embossed gusset portions 20 of the container 10 disclosed herein are believed to reduce this stickiness or surface tension. More particularly, it is believed that the mounds 32 and/or depressions 34 reduce the surface area of the plastic inner and outer surfaces 26A,26B of the gusset segments 22 that are in mating contact with other plastic surfaces of the bag 10A as it is being filled. It is also believed that air and/or the material with which the bag 10A is being filled can more easily penetrate the gusset segments 22 when the bag 10A is being filled because the air and/or material can more easily spread through the gusset segment 22 by bypassing the mounds 32 and/or depressions 34, which helps to open or expand the gusset segments 22. The gusset segments 22 may therefore be more likely to expand when being filled, and thus the embossed sections 30 of the gusset portions 20 may help to reduce the stickiness of mating surfaces and may help to resolve the side gusset blocking issue associated with conventional plastic containers with no embossing in the side gusset sections.

Many configurations of the embossed section 30 are possible to achieve the above described functionality. Some of these are now described in greater detail.

Still referring to FIG. 1, the mounds 32 of the embossed section 30 protrude from only the inner surfaces 26A of each of the gusset segments 22. Each gusset portion 20 in FIG. 1 has only two gusset segments 22, and the mounds 32 protrude from the inner surfaces 26A of each gusset segment 22. It is believed that having the mounds 32 protrude from the inner surfaces 26A of the gusset segments 22 reduces the contact surface area between the inner surfaces 26A and a corresponding interior surface of the bag 10A with which the inner surfaces 26A mate when the gusset portions 20 are folded (i.e. not expanded). The contact of the mounds 32 with the interior surface of the bag 10A also helps to space the inner surface 26A away from the interior surface. This “inside-inside” configuration of the mounds 32 may help prevent the inner surfaces 26A from sticking to the interior surface of the bag 10A, and thus facilitate the expansion of the gusset portion 20.

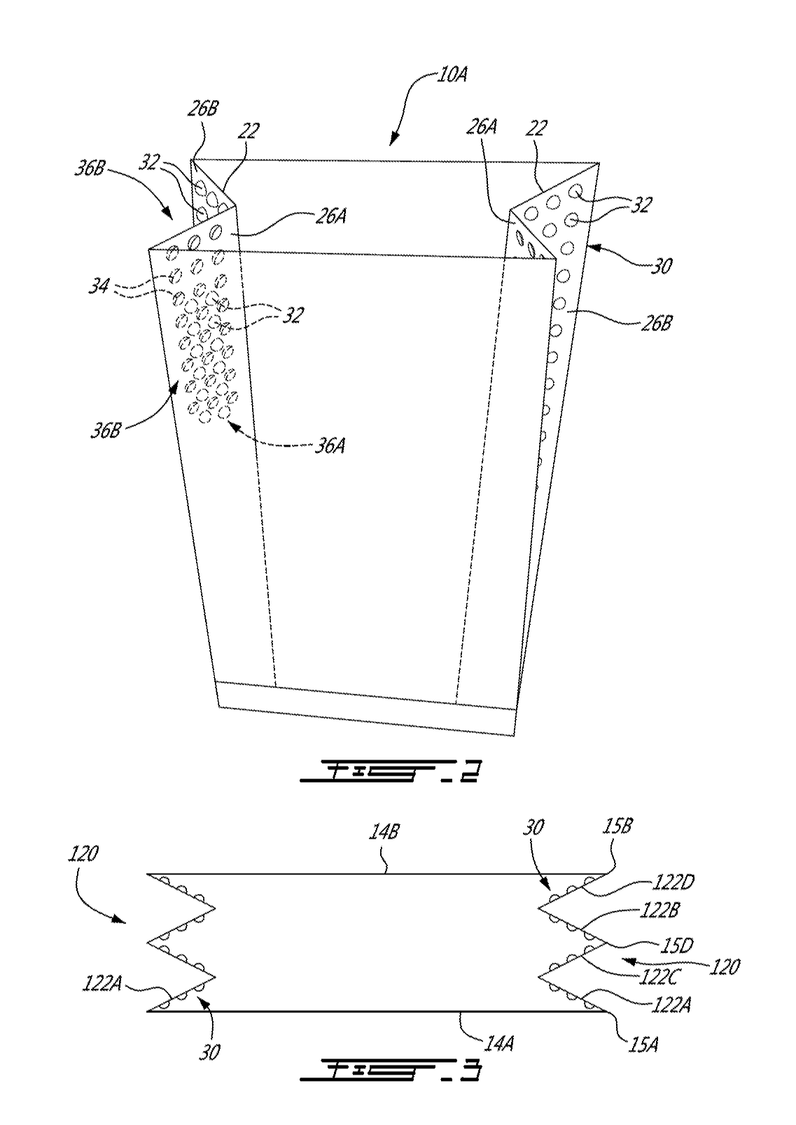

Referring to FIG. 2, the mounds 32 of the embossed section 30 protrude from the outer surfaces 26B of one or more of the gusset segments 22. In this configuration, the depressions 34 are therefore into the inner surface 26A. It is believed that having the mounds 32 protrude from the outer surfaces 26B reduces the contact surface area between the outer surface 26B of one gusset segment 22 and the outer surface 26B of an adjacent gusset segment 22, where both outer surfaces 26B mate with each other when the gusset portions 20 are not expanded. The contact of the mounds 32 with the outer surface 26B of the adjacent gusset segment 22 of the bag 10A also helps to space these mating outer surfaces 26B away from each other. This “outside-outside” configuration of the mounds 32 may help prevent the outer surfaces 26B from sticking together, and thus facilitate the expansion of the gusset portion 20.

Still referring to FIG. 2, at least one of the gusset portions 20 has a “double” embossing pattern. More particularly, one of the embossed sections 30 has a first embossing pattern 36A and a second embossing pattern 36B. The mounds 32 of the first embossing pattern 36A protrude from the inner surface 26A of a gusset segment 22 and the depressions 34 are within the outer surface 26B. The mounds 32 of the second embossing pattern 36B protrude from the outer surface 26B of the same gusset segment 22 and the depressions 34 are within the inner surface 26A. In the illustrated embodiment, one or more of the gusset segments 22 therefore has an embossed section 30 where the mounds 32 protrude from both the inner and outer surfaces 26A,26B. In an alternate embodiment, only one of the gusset segments 22 has the embossed section 30. In such an embodiment, the remainder of the gusset segments 22 have no embossed sections 30.

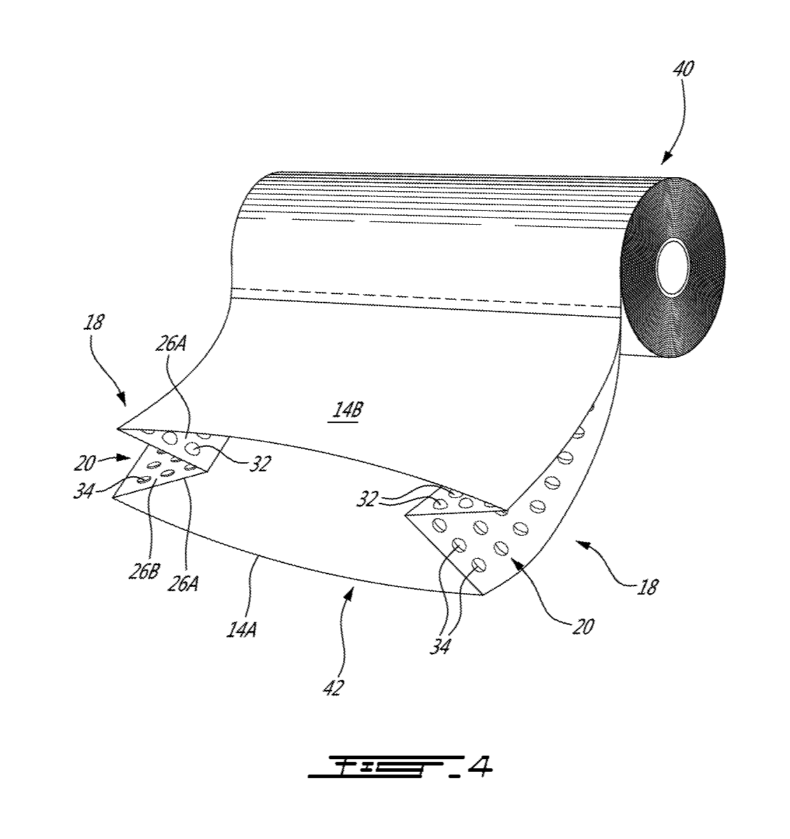

In FIG. 3, another embodiment of the gusset portions 120 is shown in a cross-sectional plane being normal to a longitudinal axis of the bag 10A. Each gusset portion 120 includes more than two gusset segments 122. More particularly, each gusset portion 120 includes first, second, third, and fourth gusset segments 122A,122B,122C,122D. The first gusset segment 122A is joined to the front wall 14A of the bag 10A along a first common fold line 15A and the fourth gusset segment 122D is joined to the back wall 14B along a second common fold line 15B. The second and third gusset segments 122B,122C are each respectively joined to the fourth gusset segment 122D and the first gusset segment 122A, and joined to each other along a third common fold line 15D. The embossed section 30 is along one or both of the first and fourth gusset segments 122A,122D. These gusset segments 122A,122D may be those that are most likely to remain stuck or blocked when the bag 10A is being filled. Therefore, only those gusset segments 122A,122D which engage the interior surface of the bag 10A and mate therewith may benefit from having an embossed section 30.

Referring to FIG. 4, there is also disclosed a roll 40 of plastic material for forming the container 10. The roll 40, also referred to as a “roll stock” or an FFS (Form-Fill-Seal) tube roll, is mountable about a spindle or other suitable rotatable support. The roll 40 is an endless web of the plastic material and is used to form the container 10 disclosed herein. The endless plastic film web is either manufactured as a tube, or a tube is initially formed from a flat film or sheet by being folded over and sealed or glued in the longitudinal direction. To form the container 10, the roll 40 is unwound, cut at lengths corresponding to the desired length of the container 10, sealed at one end, filled with the material, and then sealed at an opposite end to form the filled container 10. Since the roll 40 is essentially a preform of the container 10 to be formed, the roll 40 has many of the features of the container 10. More particularly, the roll 40 includes an expandable plastic tube 42 which is wound about a rotatable support to form a rolled-shape. The expandable plastic tube 42 has the front and back walls 14A,14B, and the sides 18. The sides 18 have gusset portions 20 which are embossed as described above.

In some conventional roll stocks of gusseted plastic tubes, the plies at the gussets tends to block as the roll is unwound, particularly at the portions of the gussets that are closest to the core of the roll stock. The core is the center drum or cylinder of the roll about which the material of the tubes is wound. The gusseted roll wind tension is highest near the core. This increased tension prevents the gussets from expanding later when they are being filled. In contrast, the embossed gusseted portions 20 of the roll 40 disclosed herein help to prevent such blockage of the gusset portions 20, as explained above.

Still referring to FIG. 4, there is also disclosed a method of forming the roll 40 of flexible plastic material. The steps of the method disclosed herein are not necessarily performed sequentially. The method includes forming a tubing 42 from a sheet of the flexible plastic material. The tubing 42 has side portions 18. The method also includes forming gussets 20 in each of the side portions 18 of the tubing 42. The method also includes embossing at least a portion of each gusset 20 to form mounds 32 protruding from one or more surfaces 26A,26B of the gusset 20, and to form depressions 34 in another surface 26A,26B of the same gusset 20. In an embodiment, the embossing of the gussets 18 occurs before forming the tubing 42. This can be achieved by embossing a sheet of the flexible plastic material prior to folding the sheet to form the tubing 42. In an embodiment, embossing includes only embossing a first half of a tubing length and leaving the remainder of a tubing length without embossing. The portion of the tubing length with embossing is the portion where the tension on the tubing 42 is highest (i.e. near the core of the roll 40). The method also includes winding the tubing 42 into the roll 40 of flexible plastic material.

The above description is meant to be exemplary only, and one skilled in the art will recognize that changes may be made to the embodiments described without departing from the scope of the invention disclosed. For example, in an embodiment, the embossed section 30 is disposed on a portion of the front or back wall 14A,14B in the vicinity of the gusset segments 22, such that the mounds 32 protrude from the interior surface of the front and back walls 14A,14B to abut against the inner surfaces 26A of the gusset segments 22. Still other modifications which fall within the scope of the present invention will be apparent to those skilled in the art, in light of a review of this disclosure, and such modifications are intended to fall within the appended claims.

1. A packaging container, comprising: an expandable plastic body having a front wall and a back wall, and a top, a bottom, and sides, each side of the body having a gusset portion extending along a length thereof, each gusset portion having gusset segments and a pair of adjacent gusset segments are joined along a common fold line, each gusset segment having an inner surface and an outer surface, at least one of the gusset segments having an embossed section, the embossed section having a plurality of mounds protruding from one of the inner and outer surfaces and a plurality of depressions corresponding to the mounds within the other of said inner and outer surfaces.

2. The packaging container as defined in claim 1, wherein the mounds of the embossed section protrude from the inner surface of the at least one of the gusset segments.

3. The packaging container as defined in claim 1, wherein each of the mounds and corresponding depressions are spaced apart from one another along the length of the gusset portion, and along a width of the at least one of the gusset segments.

4. The packaging container as defined in claim 1, wherein the embossed section extends along a complete length of the at least one of the gusset segments.

5. The packaging container as defined in claim 1, wherein each gusset portion includes only two gusset segments, the mounds of the embossed section protruding from the inner surfaces of both of the gusset segments.

6. The packaging container as defined in claim 1, wherein each gusset portion includes a first gusset segment and a second gusset segment, the first gusset segment joined to the front wall along a first common fold line and the second gusset segment joined to the back wall along a second common fold line, the embossed section being disposed on at least one of the first and second gusset segments.

7. The packaging container as defined in claim 1, wherein the mounds are unperforated protrusions from one of the inner and outer surfaces.

8. The packaging container as defined in claim 1, wherein the mounds of the embossed section protrude from the outer surface of the at least one of the gusset segments.

9. The packaging container as defined in claim 1, wherein the embossed section of the at least one of the gusset segments has a first embossing pattern and a second embossing pattern, the mounds of the first embossing pattern protruding from the inner surface of the at least one of the gusset segments and the depressions being within the outer surface, and the mounds of the second embossing pattern protruding from the outer surface of the at least one of the gusset segments and the depressions being within the inner surface.

10. The packaging container as defined in claim 1, wherein only one of the gusset segments has the embossed section.

11. A roll for forming a packaging container, the roll comprising: an expandable plastic tube in a rolled-shape having a front wall and a back wall, the front and back walls meeting at sides of the expandable plastic tube, each side of the expandable plastic tube having a gusset portion extending along a length thereof, each gusset portion having gusset segments where a pair of adjacent gusset segments are joined along a common fold line, each gusset segment having an inner surface and an outer surface, at least one of the gusset segments having an embossed section, the embossed section having a plurality of mounds protruding from one of the inner and outer surfaces and a plurality of depressions corresponding to the mounds within the other of said inner and outer surfaces.

12. The roll as defined in claim 11, wherein the mounds of the embossed section protrude from the inner surface of the at least one of the gusset segments.

13. The roll as defined in claim 11, wherein each of the mounds and corresponding depressions are spaced apart from one another along the length of the gusset portion, and along a width of the at least one of the gusset segments.

14. The roll as defined in claim 11, wherein the embossed section extends along a complete length of the at least one of the gusset segments.

15. The roll as defined in claim 11, wherein each gusset portion includes a first gusset segment and a second gusset segment, the first gusset segment joined to the front wall along a first common fold line and the second gusset segment joined to the back wall along a second common fold line, the embossed section being disposed on at least one of the first and second gusset segments.

16. A method of forming a roll of flexible plastic material, the method comprising:
forming a tubing from a sheet of the flexible plastic material, the tubing having side portions;
forming a gusset in each of the side portions of the tubing;
embossing at least a portion of each gusset to form mounds protruding from one surface of the gusset, and to form depressions in another surface of the same gusset; and
winding the tubing into the roll of flexible plastic material.

17. The method as defined in claim 16, wherein embossing the portion of each gusset includes embossing the portion of each gusset to form the mounds protruding from an inner-facing surface of the gusset, and to form the depressions in an outer-facing surface of the same gusset.

18. The method as defined in claim 16, wherein embossing the portion of each gusset includes embossing the portion of each gusset along an entire length of the gusset.

19. The method as defined in claim 16, further comprising cutting the roll of plastic material to form a plastic container and sealing an end of the plastic container.

20. The method as defined in claim 19, further comprising filling the plastic container with material.
